(19) United States
(12) Patent Application Publication
(10) Pub. No.: US 2024/0239025 A1
(43) Pub. Date: Jul. 18, 2024

(54) ACOUSTIC METAMATERIAL AND METHOD FOR THE ADDITIVE MANUFACTURING THEREOF

(71) Applicants: SAFRAN AIRCRAFT ENGINES, Paris (FR); CENTRE NATIONAL DE LA RECHERCHE SCIENTIFIQUE, Paris (FR); UNIVERSITE DU MANS, Le Mans (FR)

(72) Inventors: Josué COSTA BAPTISTA, Québec (CA); Edith-Roland FOTSING, Québec (CA); Annie ROSS, Québec (CA); Jacky Novi MARDJONO, Moissy-Cramayel (FR); Jean BOULVERT, Moissy-Cramayel (FR); Daniel THERRIAULT, Québec (CA)

(73) Assignees: SAFRAN AIRCRAFT ENGINES, Paris (FR); CENTRE NATIONAL DE LA RECHERCHE SCIENTIFIQUE, Paris (FR); UNIVERSITE DU MANS, Le Mans (FR)

(21) Appl. No.: 18/558,994

(22) PCT Filed: May 3, 2022
(86) PCT No.: PCT/FR2022/050849

§ 371 Date: Nov. 3, 2023

(30) Foreign Application Priority Data
May 4, 2021 (CA) 3117010
May 4, 2021 (CA) 3117015

(51) Int. Cl. B29C 39/02; B29C 33/38; B29C 33/52; B29C 39/26; B29C 39/36; B29C 64/118; B29K 63/00; B29K 105/16; B29L 31/00; B33Y 10/00; B33Y 80/00; F02C 7/24

(52) U.S. Cl. CPC B29C 39/026; B29C 33/3842; B29C 33/52; B29C 39/26; B29C 39/36; B33Y 10/00; B33Y 80/00; B29C 64/118; B29K 2063/00; B29K 2105/162; B29K 2821/003; B29K 2821/006; B29K 2829/00; B29K 2831/04; B29K 2867/046; B29K 2995/0037; B29L 2031/757; F02C 7/24

(57) ABSTRACT

Embodiments of the present invention relates to an acoustic metamaterial, as well as to a method for manufacturing the same. The acoustic metamaterial includes a plurality of channels or columns each having the same cross-section with a hydraulic radius between 5 and 300 μm, which channels or columns are arranged with a periodic spacing between 2 and 600 μm. This results in a highly dense network that can provide optimal acoustic absorption and/or impedance over a wide frequency range. The method for manufacturing the same includes additive manufacturing with a plurality of consecutive material deposition steps to form, in each step, a layer comprising a plurality of periodically repeated cells separated by walls. The layers deposited in the consecutive material deposition steps are stacked with their respective cells aligned to form channels.

### BACKGROUND OF THE INVENTION

The present invention relates to the field of acoustic meta-materials, as well as that of their manufacture.

Sound absorbers have a wide range of applications. In particular, they include aeronautics, where such elements are used to at least partially absorb the noise generated by aviation engines and thus reduce its transmission to the external environment. Among the most common aviation engines are turbofan engines. A turbofan engine comprises a fan and a gas generator incorporating at least a compressor, a combustion chamber, a turbine and a nozzle. The total noise produced by such a turbofan engine can therefore comprise jet, combustion, fan, compressor and turbine noise. However, the most dominant noise is usually that emitted by the fan, which can extend over a wide frequency band, as shown in FIG. 16, with tonal components corresponding to the passing frequencies of the fan blades. In order to increase the energy efficiency of turbofan engines, the general trend is to increase their bypass ratio, that is to say, the proportion of the air flow driven by the fan compared to that used for combustion in the gas generator, and therefore the diameter of the fan. As a result, the fans of the latest generations of turbofan engines tend to rotate more slowly, and therefore emit noise at lower frequencies.

In order to reduce the noise emitted by aviation engines, it is therefore common to cover certain areas, such as the nacelles containing these engines, with sound absorbers such as honeycomb sandwich panels. In this type of sound absorbers, each cell in the honeycomb can operate as a Helmholtz resonator to attenuate noise. However, the frequency range of acoustic attenuation of such absorbers is limited and, to be effective at low frequencies, they must be particularly bulky, which is even more penalizing as the surface to be covered can be very large for very high bypass ratio turbofan engines.

As an alternative to honeycomb sandwich panels, it has therefore been proposed to use porous materials, the individual pores of which act as Helmholtz resonators. However, most of the porous materials available have too low mechanical strength, while the most resistant, such as for example the metallic material disclosed in U.S. Pat. No. 7,963,364 B2, are excessively heavy. Furthermore, they only provide significant attenuation at resonant frequencies and cannot absorb noise over a wide frequency range.

The use of additive manufacturing was proposed by Z. Liu, J. Zhan, M. Fard, and J. L. Davy in “Acoustic properties of a porous polycarbonate material produced by additive manufacturing”, Materials Letters, vol. 181, pp. 296-299, (October 2016) to produce sound absorbers including microchannels. However, these sound absorbers also only have a fairly narrow absorption frequency range.

It has also been proposed, for example by Qian, Y. J., Kong, D. Y., Liu, S. M., Sun, S. M., & Zhao, Z., in “Investigation on micro-perforated panel absorber with ultra-micro perforations.”, Applied Acoustics, 74(7), pp; 931-935 (2013), to use micro-perforated panels as sound absorbers. In order to broaden the frequency range of sound absorption, Liu, Z., Zhan, J., Fard, M., & Davy, J., in “Acoustic properties of multilayer sound absorbers with a 3D printed micro-perforated panel.” Applied Acoustics, 121, pp. 25-32 (2017), and Yang, W., Bai, X., Zhu, W., Kiran, R., An, J., Chua, C. K., & Zhou, K. in “3D Printing of Polymeric Multi-Layer Micro-Perforated Panels for Tunable Wideband Sound Absorption”. Polymers, 12(2), p. 360 (2020) also proposed superimposing several of these panels and producing them by additive manufacturing. However, these relatively fragile sound absorbers seem difficult to apply in environments in which they would be subject to abrasion or other mechanical stresses, such as in particular the nacelles of aviation engines.

Meta-materials with several layers superimposed in the direction of the thickness, produced by additive manufacturing, have been proposed in French patent application publication FR 1 761 722, as well as by Guild, M. D., Rohde, C., Rothko, M. C., & Sieck, C. F. in “3D printed acoustic metamaterial sound absorbers using functionally-graded sonic crystals”, Proceedings of Euronoise (2018). Acoustic meta-material can be understood as a periodically structured medium the periodically repeated constituent units of which collectively affect the passage of acoustic waves. In the case of the aforementioned meta-materials, each superimposed layer can have a lattice with a different periodicity, so as to broaden its attenuation frequency range.

### OBJECT AND SUMMARY OF THE INVENTION

The present disclosure aims at proposing, in a first aspect, an acoustic meta-material combining a high level of sound absorption with good mechanical resistance, including abrasion. This acoustic meta-material can comprise a plurality of channels each having the same cross section with a hydraulic radius between 5 and 300 μm, these channels being disposed with a periodic spacing between adjacent channels between 2 and 600 μm. Thus it is possible to obtain a highly dense array of acoustic microchannels that can provide optimal sound absorption and/or impedance over a wide frequency band, with maximum absorptions at least at certain low frequencies such as those dominant in the emission spectrum of high and very high bypass ratio turbofan engine fans.

The channels may have a substantially polygonal, for example triangular, square, rectangular or hexagonal cross section. “Substantially polygonal” means that the angles of the cross section can be rounded as a result of manufacturing constraints. The cross section can, however, also be substantially round or oval. “Substantially round or oval” means that the contour of the cross section can also have flat spots also due to manufacturing constraints.

In order to broaden its sound absorption frequency band, the acoustic meta-material may include several pluralities of channels, each plurality of channels having a different cross section and/or periodic spacing of the channels. In particular, these different pluralities of channels can be arranged in directly adjacent layers in a direction of the thickness of the meta-material, such that the acoustic meta-material includes several layers stacked in the direction of the thickness, each layer comprising a plurality of channels having a different cross section and/or periodic channel spacing. It is nevertheless also possible to vary the cross section and/or the channel spacing in a plane perpendicular to the direction of the thickness of the meta-material.

In order to increase the length of the channels without increasing the thickness of the acoustic meta-material, one or more of the channels can be inclined relative to a direction of thickness of the meta-material, and in particular be helical. They can, alternatively or in addition, be bent in order to increase their length.

A second aspect of the present invention relates to a process for additive manufacturing of the acoustic meta-material of the first aspect. This additive manufacturing process may comprise several consecutive steps of depositing material to form, in each step, a stratum including a plurality of periodically repeated cells, separated by walls. The strata deposited in the consecutive material deposition steps may be stacked with their respective cells aligned to form the channels.

The material used in the process according to this second aspect may comprise a thermoplastic polymer, and the deposition can then be carried out by fused wire deposition in order to allow the manufacture of sufficiently fine structures. Alternatively, however, the material used in this process could comprise a thermosetting resin, and the deposition of material can then be carried out, in a manner similar to the molten wire deposition, by extrusion of this thermosetting resin. In order to mechanically reinforce the acoustic meta-material, the material used in this process can also comprise, apart from the thermoplastic polymer or the thermosetting resin, suspended solid particles, such as in particular fibers, and more particularly carbon fibers. Other types of solid particles, such as, in particular, nanoparticles or microbeads, in particular made of silica, are also possible. Thanks to these solid particles, the acoustic meta-material will be able to have significant mechanical and thermal resistance, as well as abradability properties.

A third aspect of the present disclosure relates to another process for manufacturing an acoustic meta-material also combining a high level of sound absorption with good mechanical resistance, including abrasion. In a first additive manufacturing step of this process for manufacturing an acoustic meta-material, a mold can be produced by depositing a plurality of stacked strata which can each comprise a plurality of periodically repeated cells, separated by walls, the cells of the plurality of stacked strata can be aligned to form channels. In a second step of the process, the channels can be filled with a fluid material, which can then be solidified before the mold is removed.

With the process following this third aspect, it is possible to produce a meta-material comprising a highly dense periodic arrangement of columns which can also offer optimal sound absorption and/or impedance over a wide frequency band, with maximum absorptions at least at certain low frequencies such as those dominant in the emission spectrum of high and very high bypass ratio turbofan engine fans.

The hollow cells can in particular have a hydraulic radius between 5 and 300 μm, so as to obtain columns of corresponding width in the acoustic meta-material, while the walls can have a minimum width of between 2 μm and 600 μm to obtain thus a corresponding lateral distance between the columns. With these dimensions, it is possible to obtain sonic crystals with optimal absorption and acoustic impedance over wide frequency ranges comprising the dominant frequencies in the emission spectrum of high and very high bypass ratio turbofan engine fans.

The mold channels can have a length of between 1 and 150 mm, so as to obtain columns of corresponding height. Thus, the acoustic meta-material obtained by this process may have a thickness barely greater than this length, thus facilitating its integration, particularly in and around an aviation engine.

The cells can be substantially polygonal, round or oval, so as to obtain columns of equivalent cross section in the resulting acoustic meta-material. It is also possible to combine cells of different shapes in the same mold, or even in the same stratum of the mold.

Moreover, a shape and/or size of cells of different strata, among the stacked strata, may be different, so as to vary the cross section of the channels, and therefore of the columns, over their length, in particular in order to optimize the acoustic response of the acoustic meta-material at several frequency bands.

The mold may also comprise one or more lateral conduits between the channels, so as to form, during their filling with the fluid material and the solidification of the latter, spacers and other lateral reinforcements between the columns of the acoustic meta-material.

In order to facilitate the step of removing the mold, it can be made of a water-soluble material comprising, for example, a polyvinyl alcohol (PVA), a copolymer of butanediol and vinyl alcohol (BVOH), or a polylactic acid (PLA). The step of removing the mold can then be carried out by leaching, in particular by leaching in an ultrasonic bath.

In order to allow the manufacture of sufficiently fine structures, the additive manufacturing of the mold can be carried out by depositing a wire of extruded material, and in particular by a molten wire deposition process. The material used to manufacture the mold can therefore comprise a thermoplastic polymer, but a thermosetting resin is also possible.

The fluid material used in the mold filling step may comprise a resin, such as for example an epoxy resin, and the step of solidifying the mold material then comprises a polymerization of the resin. This polymerization can be activated and/or accelerated thermally, although other means of activation, for example by ultraviolet, are also possible. Moreover, it is also possible to instead use a molten thermoplastic polymer as a fluid material in the filling step.

In order to mechanically reinforce the resulting acoustic meta-material, the fluid material may comprise suspended solid particles, such as in particular silica microbeads or nanoparticles, or fibers, and in particular carbon fibers.

A fourth aspect of this disclosure relates to the acoustic meta-material manufactured by the manufacturing process of the third aspect and including a plurality of columns extending from a common base.

Finally, a fifth aspect of this disclosure relates to a turbomachine, in particular a gas turbine engine such as a turbofan engine, including the acoustic meta-material of the first aspect or the fourth aspect, as a sound absorber. In particular, in a turbofan engine, the acoustic meta-material could be integrated into a wall delimiting a fan air flow path and/or into a gas generator casing.

### BRIEF DESCRIPTION OF THE DRAWINGS

The invention will be well understood and its advantages will appear better, upon reading the detailed description which follows, of several embodiments represented by way of non-limiting examples. The description refers to the appended drawings in which:

FIG. 1 is a longitudinal sectional view of a turbofan engine,

FIG. 2 is a cutaway thickness view of a first acoustic meta-material suitable for use as a sound absorber in the turbofan engine of FIG. 1,

FIGS. 3A to 3G are cross-sectional views, along plane III-III, of different possible alternative shapes of the meta-material channels of FIG. 2,

FIG. 4 is a graph illustrating the sound absorption coefficient as a function of frequency, for several acoustic meta-materials with channels having different shapes and widths,

FIG. 5 is a thickness sectional view of an alternative embodiment of the acoustic meta-material, with channels of different widths on different layers of the acoustic meta-material,

FIG. 6 is a graph illustrating the sound absorption coefficient as a function of frequency, for several examples of multilayer acoustic meta-material,

FIGS. 7A, 7B and 7C are thickness sectional views of several other alternative embodiments of the acoustic meta-material,

FIG. 8 illustrates a device for implementing an additive manufacturing process,

FIGS. 9A and 9B illustrate two alternative material deposition plots for the manufacture of a stratum,

FIG. 10 is a perspective view of a second acoustic meta-material suitable for use as a sound absorber in the turbofan engine of FIG. 1,

FIGS. 11A to 11G are cross-sectional views, along plane XI-XI, of different possible alternative shapes of the columns of the meta-material of FIG. 10,

FIG. 12 is a graph illustrating the sound absorption coefficient as a function of frequency, for several acoustic meta-materials with channels having different shapes and widths,

FIG. 13 is a thickness sectional view of an alternative embodiment of the second acoustic meta-material, with columns of different widths on different layers different from the acoustic meta-material,

FIG. 14 is a thickness sectional view of another alternative embodiment of the second acoustic meta-material, with spacers laterally connecting the columns of the acoustic meta-material,

FIG. 15 illustrates a step of filling the mold of the second acoustic meta-material, and

FIG. 16 is a graph illustrating the intensity of the noise emitted by a turbofan engine as a function of frequency.

### DETAILED DESCRIPTION OF THE INVENTION

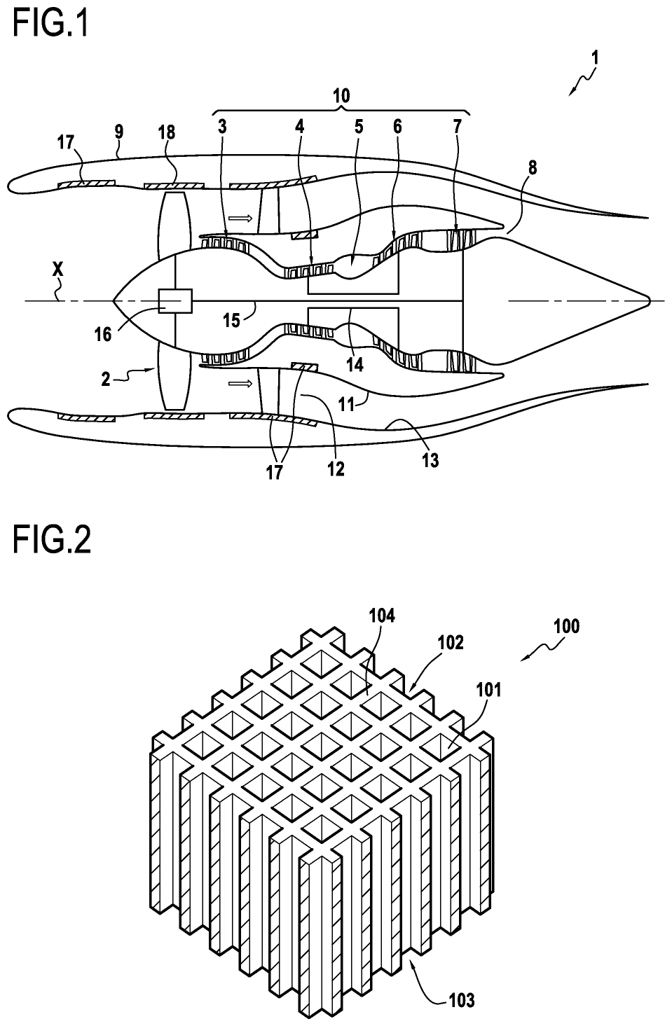

FIG. 1 schematically illustrates a turbomachine 1, more specifically a turbofan engine. In the direction of fluid flow, this turbofan engine may comprise a fan 2, a low pressure compressor 3, a high pressure compressor 4, a combustion chamber 5, a high pressure turbine 6, a low pressure turbine 7 and a nozzle 8. The assembly can be surrounded by a nacelle 9. The compressors 3,4, the combustion chamber 5 and the turbines 6, 7 together form the gas generator 10, which can in turn be surrounded by a shroud 11 leading into the nozzle 8. Thus, an air flow path 12 of the fan 2 can be defined between the shroud 11 of the gas generator 10 and an internal wall 13 of the nacelle 9. The high pressure turbine 6 can be connected to the high pressure compressor 4 by a first rotating shaft 14 for driving the latter, while the low pressure turbine 7 can be connected to the fan 2 and to the low pressure compressor 3 by a second rotating shaft 15 coaxial with the first rotating shaft 14, similarly. In the context of high and very high bypass ratio engines, a reduction gear 16 can be mechanically interposed between the second rotating shaft 15 and the fan 2, in order to reduce the rotation speed of the fan 2 and prevent the blade tips of the fan 2 from reaching excessive speeds.

Each of these elements of the turbomachine 1 can generate noise, but the noise generated by the fan 2 is generally dominant. Furthermore, in high and very high bypass ratio engines, and in particular in those equipped with a reduction gear 16, a large portion of the noise from the fan 2 can be concentrated in low frequencies, as illustrated in FIG. 17, showing the sound pressure level (SPL) as a function of frequency f. In order to absorb at least a portion of the noise from the fan 2, noise absorbers 17 can be integrated into the internal wall 13 of the nacelle 9, in particular upstream and downstream of the blades of the fan 2. As illustrated, however, it is also possible to integrate noise absorbers 17 into the shroud 11 of the gas generator 10, or even into the casing of the latter.

Typically, the sound absorbers 17 are formed by honeycomb sandwich panels. However, in engines with high, or even very high, bypass ratios, these panels can represent a significant penalty in terms of mass and size. Furthermore, it can be difficult to dispose them directly facing the tips of the fan blades, where the noise emission can nevertheless be the most intense, since the internal wall 13 of the nacelle 9 typically comprises an abradable material 18 at this location, in order to absorb the occasional friction of the tips of the blades of the fan 2 due to their transient deformations.

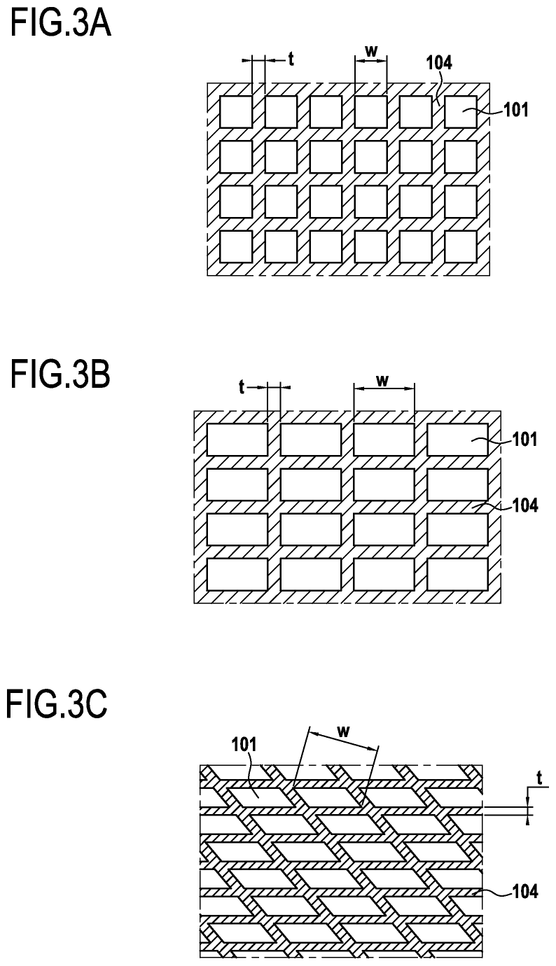

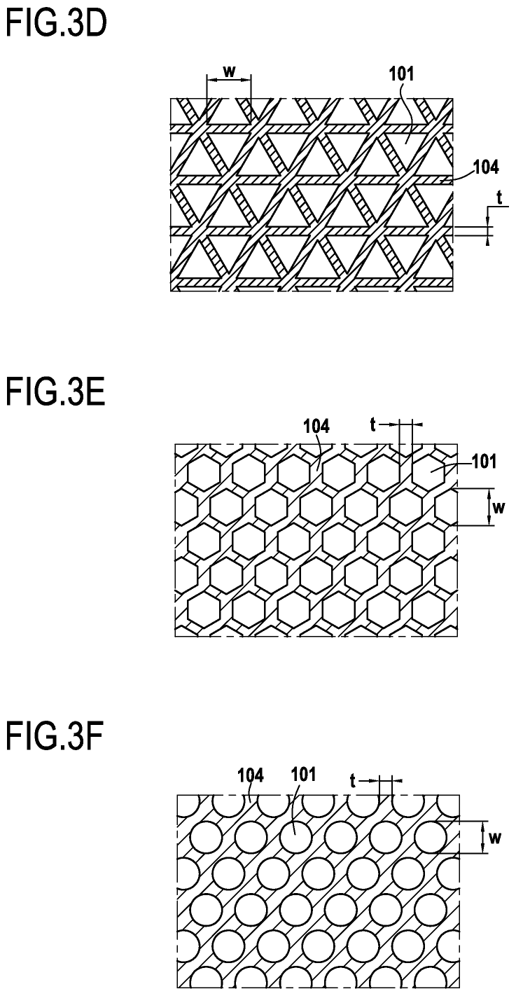

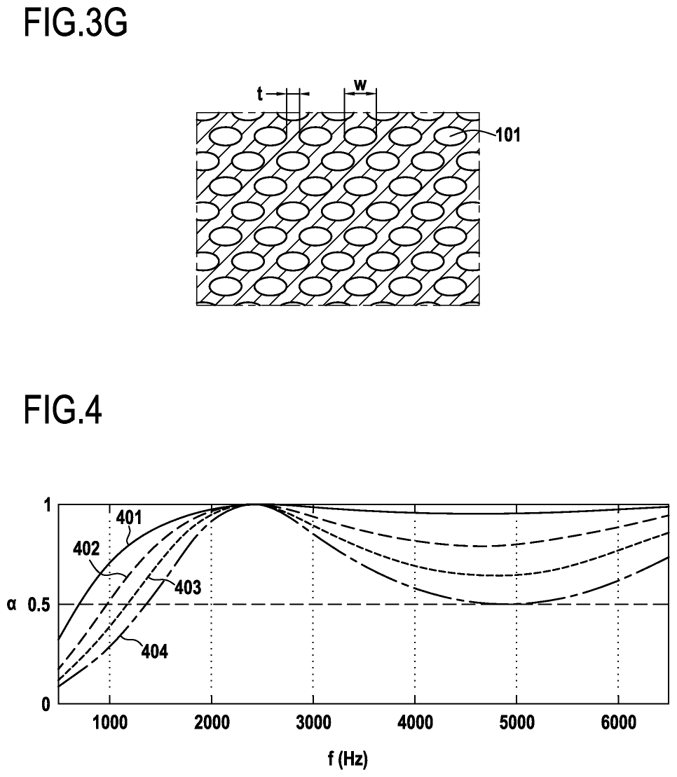

FIGS. 2 to 3G illustrate several embodiments of a noise absorber 17 formed by an acoustic meta-material 100 which can effectively replace honeycomb sandwich panel noise absorbers, with less weight and space requirement, and even be disposed directly opposite the blades of the fan 2 as an abradable material 18.

As illustrated in FIG. 2, this acoustic meta-material 100 can include a plurality of channels 101, of high density and arranged periodically and extending from an exposed surface 102 of the meta-material 100 to its base 103. The channels 101 can be separated from each other by walls 104.

As illustrated in FIGS. 2 and 3A, in cross section, each channel 101 can have a substantially square outline. However, other substantially polygonal shapes, such as for example substantially rectangular, diamond, triangular or hexagonal shapes, are also possible, as illustrated respectively in FIGS. 3B, 3C, 3D and 3E. Non-polygonal shapes, such as for example substantially round or oval shapes, are also possible, as illustrated respectively in FIGS. 3F and 3G.

A hydraulic radius rₕ of the cross section of each channel 101 can be defined according to the formula rₕ=2A/P, where A and P represent, respectively, the area and the perimeter of the cross section of the channel 101. Independently of the shape of their cross section, each channel 101 can have a hydraulic radius rₕ of, for example, between 5 μm and 300 μm, which, for channels 101 with a square or round section, corresponds to a width W between 10 μm and 600 μm, although a shape coefficient can be applied to take into account the edge effects of channels with cross sections of different shapes. The periodic spacing t between adjacent channels 101 can for example be between 2 μm and 600 μm.

The sound absorption of the different frequencies can vary significantly as a function of the hydraulic radius rₕ, and therefore of the width W, as well as the periodic spacing t of the channels 101. Thus, FIG. 4 illustrates the absorption coefficient α [ALPHA] as a function of the acoustic frequency f for examples of acoustic meta-materials 100 with different values of width W and periodic spacing t of the channels 101. Thus, the curves 401, 402, 403 and 404 correspond to meta-acoustic materials 100 with substantially square channels 101 with widths W and periodic spacings t of, respectively, 133 and 2 μm, 175 and 50 μm, 215 and 100 μm, and 265 and 155 μm. It can be appreciated how, although the maximum absorption coefficient is close to one, and corresponds to substantially the same frequency f between 2000 and 3000 Hz for the different values of W and t, the absorption frequency band broadens with a decrease in W and t.

In order to broaden the sound absorption range of the meta-material 100, it is possible to combine pluralities of channels 101 with different periodic spacings and/or cross sections of different shapes and dimensions in the same meta-material 100. Thus, it can be considered that the meta-material 100 includes several layers superimposed in one direction of the thickness, the channels 101 having a different cross section and/or a different spacing per layer. It is even possible to include layers with functionalities other than sound absorption, and therefore not comprising regularly spaced channels or having the claimed dimensions. In order to avoid obstruction of the channels 101 of a layer by adjacent layers, the channels of the different layers can be aligned and the mesh pitch, that is to say the sum of the width W and the spacing t, corresponding to each layer being an integer multiple of the minimum mesh pitch among the different layers. In particular, the mesh pitch of each layer can be 2ⁿ times the minimum mesh pitch among the different layers, where n is an integer. With a constant spacing t and a minimum width Wₘᵢₙ, the width W would therefore follow the equation W=(Wₘᵢₙ+t)ⁿ−t.

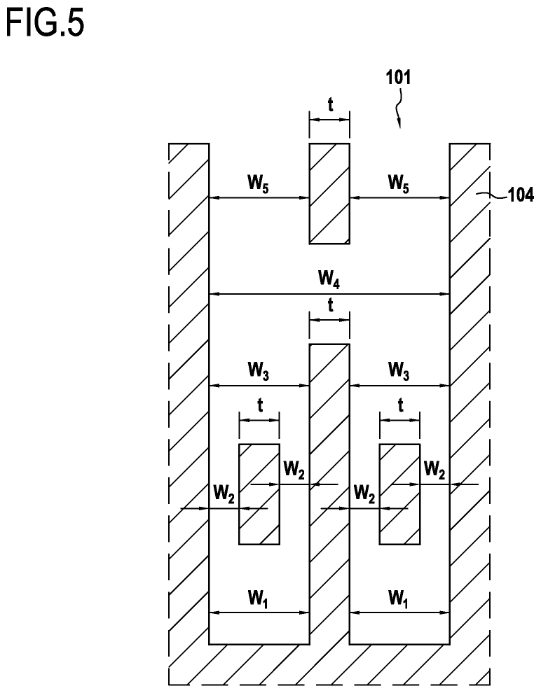

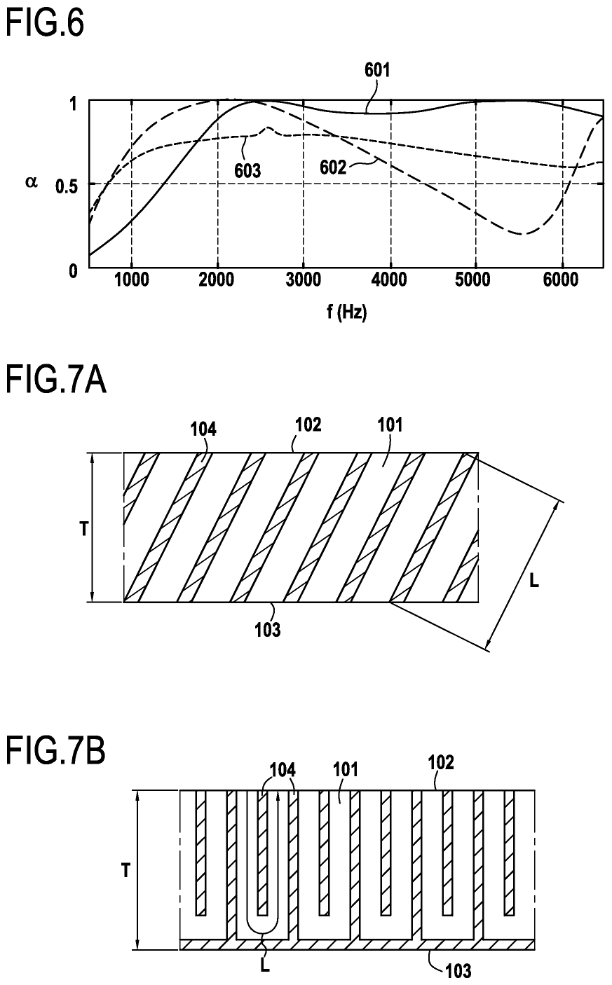

FIG. 5 illustrates a first example of acoustic meta-material 100 with five superimposed layers 100₁, 100₂, 100₃, 100₄ and 100₅, having respective thicknesses h₁, h₂, h₃, h₄ and h₅ of 6 mm each and channels 101 of square section, and where the width W₁ of the channels of the first layer 100₁ is 496 μm, the width W₂ of the channels of the second layer 100₂ is 148 μm, the width W₃ of the channels of the third level 100₃ is 496 μm, the width W₄ of the channels of the fourth level 100₄ is 1192 μm, and the width W₅ of the channels of the fifth level 100₅ is 496 μm, with a constant spacing t between channels 101 of 200 μm in each of the layers, so as to obtain an absorption coefficient α close to 1 over a wide frequency range f ranging from 2500 to 6500 Hz, as illustrated by curve 601 of FIG. 6.

Other multilayer configurations are also possible. Thus, according to a second example, the acoustic meta-material can only comprise two superimposed layers with respective thicknesses of 1 and 29 mm, and where the width of the channels of the first layer is 100 μm and that of the channels of the second layer is 9 mm, with a constant spacing t of 200 μm between channels 101 in each of the layers, so as to obtain a high absorption coefficient α over a frequency range f ranging from 1000 to 3000 Hz, as illustrated by the curve 602 of FIG. 6. According to a third example, the acoustic meta-material can comprise thirty superimposed layers, each with 1 millimeter of thickness and a constant spacing t between channels of 200 μm, and a width of the channels of 4.11 mm for layers no 1, 6, 12, 15 to 17, 20, and 22 to 24; 8.42 mm for layers no 2, 8, 11, 18, 27 and 29; 69.4 μm for layers no 3, 19, 21, 25 and 26; 1.95 mm for layers no 4, 5, 7, 13, 14 and 30; and 338.8 μm for layers no 9, 10 and 28; so as to obtain a high absorption coefficient α over a wider frequency range f ranging from 1000 to 4500 Hz, as illustrated by curve 603 in FIG. 6.

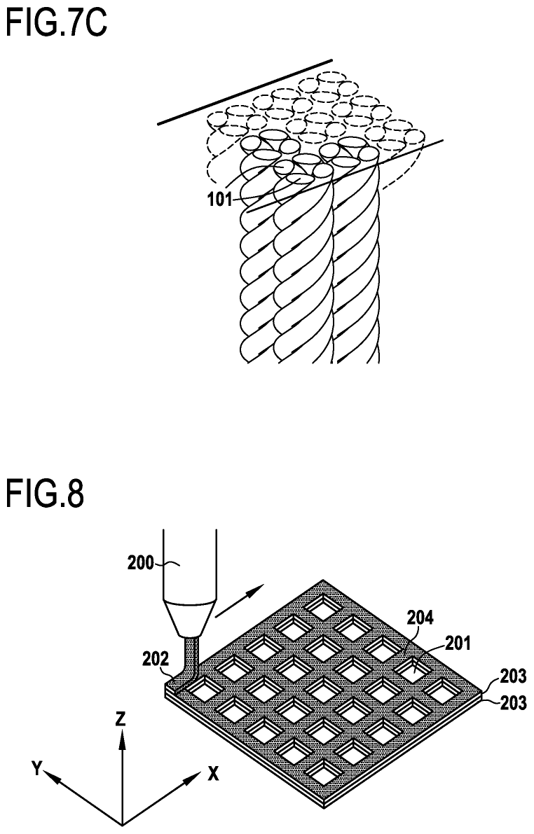

It is also possible to tilt the channels 101 relative to the direction of the thickness T of the meta-material 100 as illustrated in FIG. 7A, or even to fold them as illustrated in FIG. 7B, in order to maximize the length of the channels 101 for a limited thickness T of the meta-material 100 between its base 103 and its exposed surface 102. Furthermore, in the same object, at least some of the channels 101 can be wound helically around a central axis, as shown in FIG. 7C.

The base 103 and the walls 104 of the acoustic meta-material 100 can be made of thermoplastic polymer, for example polyetherimide (PEI) or polyetheretherketone (PEEK), or of thermosetting resin, for example an epoxy resin like that forming the abradable material sold by 3M® under the name Scotch-Weld® EC-3524 B/A. In order to reinforce this material, in particular when the acoustic meta-material 100 is intended to be disposed opposite rotating parts, and in particular the rotating blades of a fan 2, it can be reinforced by solid particles, embedded in the mass, for example fibers, and in particular carbon fibers, microspheres, for example glass microbeads, or nanoparticles such as silica powder. Depending on the material and reinforcements used for the manufacture of the acoustic meta-material, said reinforcements can have significant mechanical and thermal resistance as well as abradability properties.

The acoustic properties (for example impedance and absorption) of the acoustic meta-material 100 can be simulated with the Transfer Matrix Method or “TMM”. In this method, the equivalent fluid wave number and equivalent characteristic impedance can be calculated using the semi-phenomenological Johnson-Champoux-Allard-Lafarge (JCAL) model describing the visco-inertial dissipative effects inside of a porous medium, from six parameters: porosity, tortuosity, viscous and thermal length and viscous and thermal permeability, which can be simulated with the Multi-scale Asymptotic Method or “MAM”. When the acoustic meta-material 100 has several distinct layers, the equivalent fluid wave number and the equivalent characteristic impedance can be calculated separately for each layer.

From the model allowing to calculate the acoustic properties of the meta-material 100, the shape, dimensions and arrangement of the channels 101 of the acoustic meta-material 100 can be defined according to the frequency ranges for which optimal acoustic impedance and/or absorption are/is desired, by applying an optimization algorithm, such as for example the Nelder-Mead iterative optimization method. At each iteration of the optimization algorithm, these dimensional parameters of the acoustic meta-material 100 can be adjusted to meet other constraints, such as for example that of avoiding the obstruction of the channels 101 of each layer by the adjacent layers.

The acoustic meta-material 100 can be produced by an additive manufacturing process based on the extrusion of material, such as for example the fused deposition process used for thermoplastic materials. These processes, particularly suited to the manufacture of complex shapes with thin walls, include several consecutive steps of material deposition. In each of these steps, an extruder head 200 can move along a path 201 in a transverse plane X-Y by depositing the material 202, which then solidifies so as to form a stratum 203. By moving this transverse plane X-Y in an orthogonal direction Z after the deposition of each stratum 203, it is possible to stack these strata 203 to form the acoustic meta-material 100, as illustrated in FIG. 8. In order to form the channels 101, each stratum 203 can include a plurality of cells 204 periodically repeated, separated by the walls 104 formed by the deposition of the material 202, and the strata 203 deposited in the consecutive steps of material deposition can be stacked with their respective cells 204 aligned.

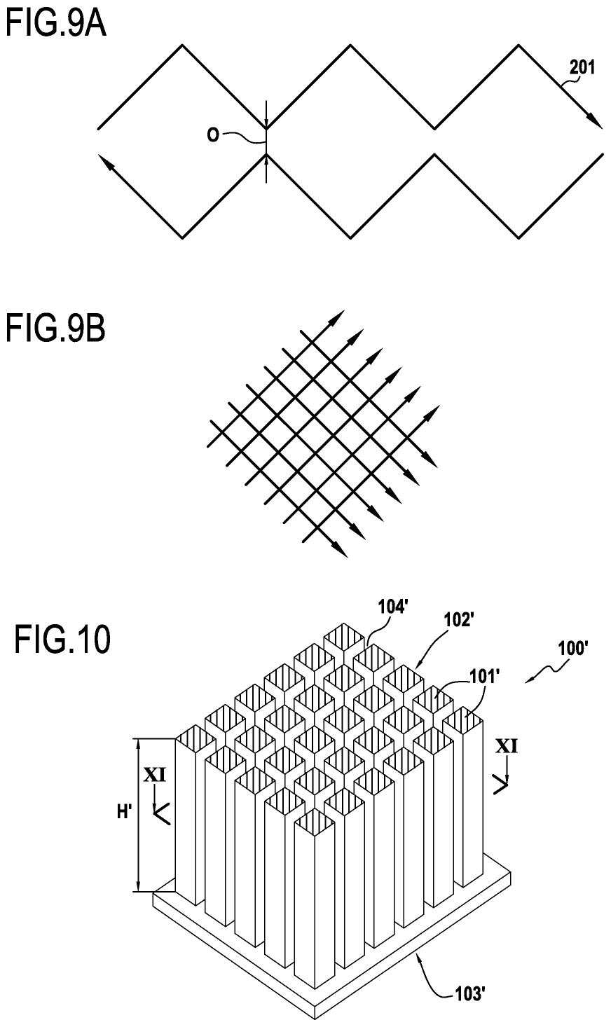

In order to at least partially avoid the intersection of the extruded material 202 during the deposition of a stratum 203, which could cause the formation of pores between the channels 101, the path 201 can be a zig-zag, as illustrated in FIG. 9A. To avoid an accumulation of material and the formation of pores at the intersections between the walls 104, a distance O can be maintained between the angles 205 of the path 201 at these intersections.

However, it is also possible, for the same shape of cells 204, to have a path 201 with long intersecting segments, as illustrated in FIG. 9B.

As illustrated in FIG. 10, an acoustic meta-material 100′ according to another embodiment may include a plurality of columns 101′ arranged periodically and extending from a common base 103′ to an exposed face 102′ of the meta-material 100′. The columns 101′ can be separated from each other by gaps 104′. Each column 101′ can have a total height H, for example, of between 1 and 150 mm.

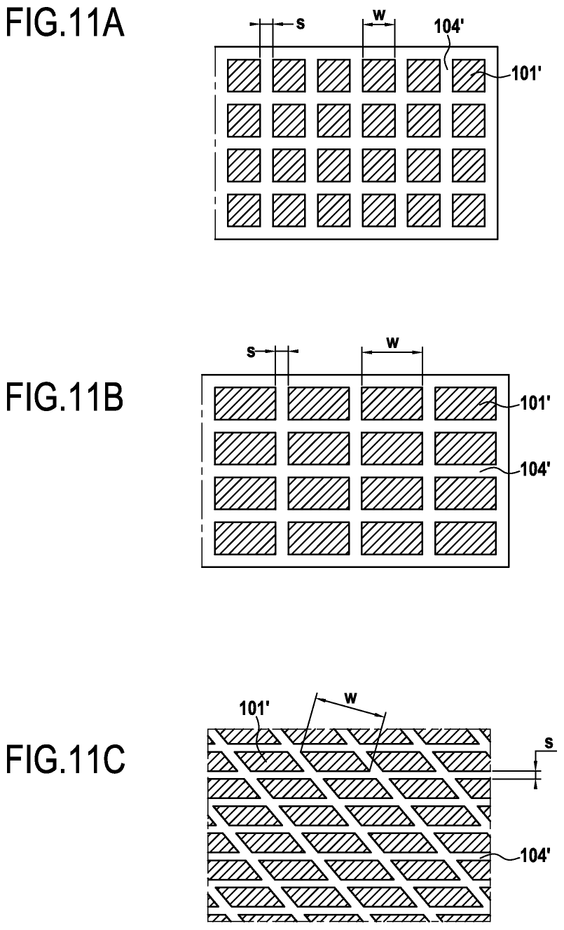

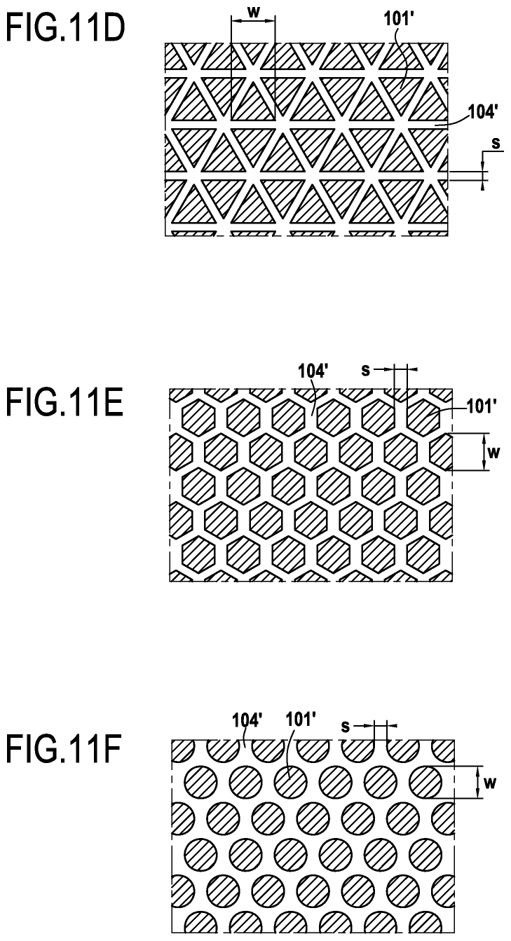

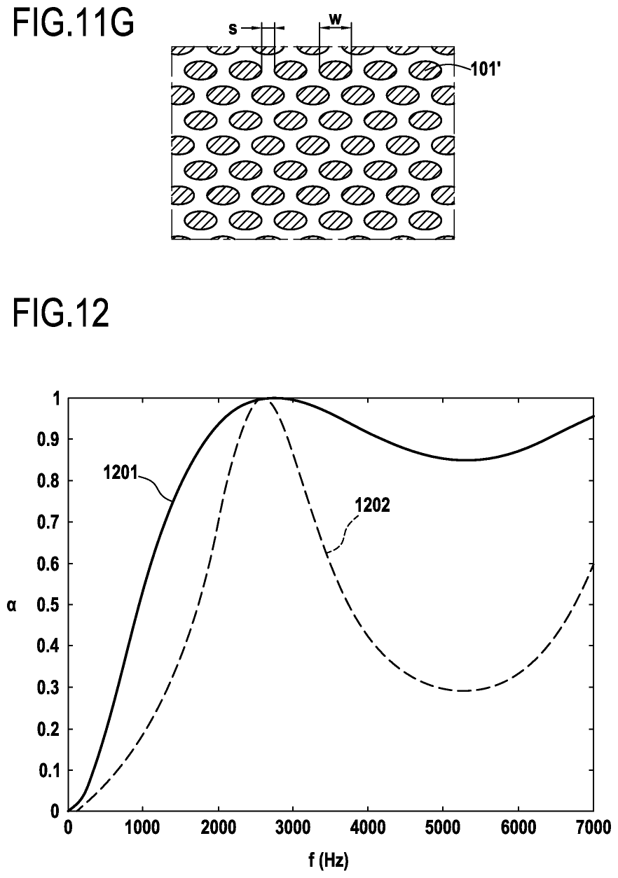

As illustrated in FIGS. 10 and 11A, in cross section, each column 101′ can have a substantially square outline. However, other substantially polygonal shapes, such as for example substantially rectangular, diamond, triangular, or hexagonal shapes are also possible, as illustrated respectively in FIGS. 11B, 11C, 11D and 11E. Non-polygonal shapes, such as for example substantially round or oval shapes, are also possible, as illustrated respectively in FIGS. 11F and 11G.

A hydraulic radius rₕ of the cross section of each column 101′ can be defined according to the formula rₕ=2A/P, where A and P represent, respectively, the area and the perimeter of the cross section of the column 101′. Independently of its shape, the cross section of each column 101′ can have a hydraulic radius rₕ of, for example, between 5 μm and 300 μm, which, for columns 101′ with a square or round section, corresponds to a width W between 10 μm and 600 μm, although a shape coefficient can be applied to take into account the edge effects of columns with cross sections of different shapes. The columns 101′ can have a periodic spacing s between adjacent columns 101′ for example of between 2 μm and 600 μm. As illustrated in the graph in FIG. 12, the dimensions in these intervals allow a particularly high absorption coefficient α [ALPHA] for frequencies f between 200 and 10000 Hz, frequencies typically dominant in the noise of a high or very high bypass ratio turbofan engine.

In FIG. 12, the curve 1201 illustrates the absorption coefficient α [ALPHA] as a function of frequency for a meta-material 100′ including columns 101′ of 30 mm height, with a square cross section having a width W of 130 μm, and a periodic spacing s of 100 μm, while the curve 1202 illustrates that for a meta-material 100′ including columns 101′ of square cross section and the same height, but a width W of 1.15 mm and a periodic spacing s of 200 μm. It can be appreciated that, although the maximum absorption coefficient is close to 1 and corresponds to a frequency f between 2500 and 3000 Hz in both cases, in curve 1201 the absorption coefficient α [ALPHA] remains high on a much wider frequency range than in the curve 1202.

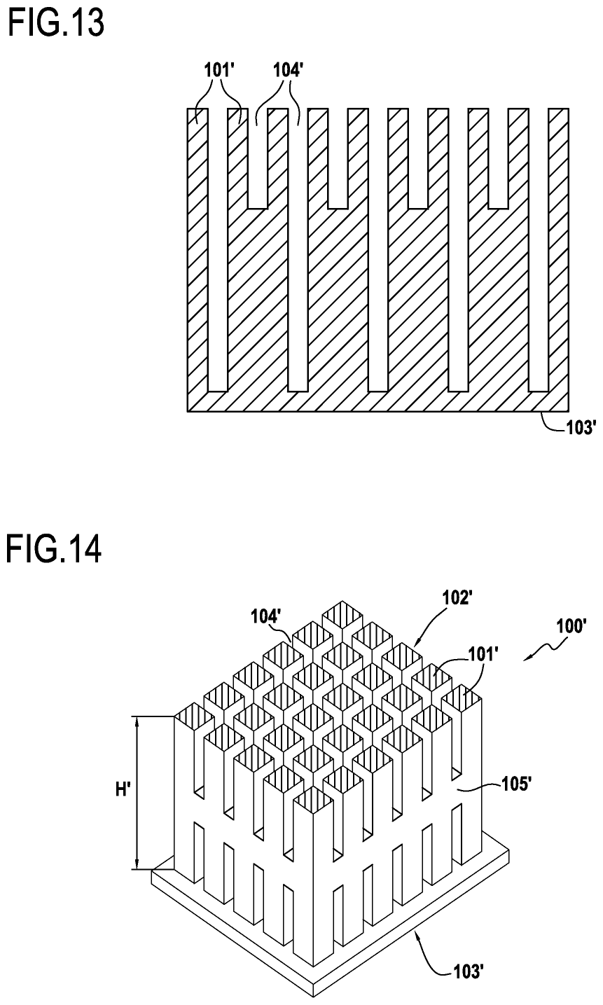

It is possible to combine columns 101′ with cross sections of different shapes and dimensions in the same meta-material 100′, or even to have different shapes and dimensions (for example different maximum widths) at different heights from the base in order to adapt the acoustic meta-material 100′ to the attenuation of several different acoustic frequencies, as illustrated in FIG. 13. It is even possible to include layers with functionalities other than sound absorption, and therefore not comprising regularly spaced columns or having the aforementioned dimensions. Furthermore, in order to laterally reinforce the columns 101′, adjacent columns 101′ can be locally connected by spacers 105′ formed integrally with the columns, as illustrated in FIG. 14. The base 103′ and the columns 101′ of the acoustic meta-material 100′ can be made of polymer, for example polyepoxy.

The acoustic meta-material 100′ can be produced by molding. In a first step, a mold 210 can be produced by an additive manufacturing process based on the extrusion of material, such as for example the fused wire deposition process used for thermoplastic materials. In each of the consecutive material deposition steps of this process, an extruder head 200 can move along a path 201 in a transverse plane X-Y by depositing the material 202, which then solidifies so as to form a stratum 203. By moving this transverse plane X-Y in an orthogonal direction Z after the deposition of each stratum 203, it is possible to stack these strata 203 to form the mold 210, as illustrated in FIG. 8. Each stratum 203 can include a plurality of cells 204 periodically repeated, separated by walls 205 formed by the deposition of the material 202, and the strata 203 deposited in the consecutive steps of material deposition can be stacked with their respective cells 204 aligned, so as to form channels 206 with sizes, shapes and spacings corresponding to those of the columns 101′. Thus, the maximum width of the channels 206 can be substantially equal to the maximum width W of the columns 101′, the minimum thickness of the walls 205 can be substantially equal to the minimum spacing t′ between the columns 101′, and the length of the channels 206 can be substantially equal to the height H′ of the columns 101′. Like those of the columns 101′, the cross section of each channel 206′ in the transverse plane X-Y can vary according to the height in the orthogonal direction. The mold 210 can also comprise lateral conduits between these channels 206 in order to form the spacers 105′.

When the meta-material 100′ must include several layers, with columns 101′ whose width W and/or spacing s varies depending on the layers, in order to avoid obstruction of the channels 206′ corresponding to a layer by the walls 104 of adjacent layers, the channels 206′ of the different layers can be aligned and the mesh pitch, that is to say the sum of the width W and the spacing s, corresponding to each layer can be an integer multiple of the minimum mesh pitch among the different layers. In particular, the mesh pitch of each layer can be 2ⁿ times the minimum mesh pitch among the different layers, where n is an integer. With a constant spacing s and a minimum width Wₘᵢₙ, the width W would therefore follow the equation W=(Wₘᵢₙ+s)ⁿ−s.

In order to at least partially avoid the intersection of the extruded material 202 during the deposition of a stratum 203, which could cause the formation of pores between the channels 104, the path 201 can be zig-zag, as illustrated in FIG. 9A.

However, it is also possible, for the same shape of cells 204, to have a path 201 with long intersecting segments, as illustrated in FIG. 9B.

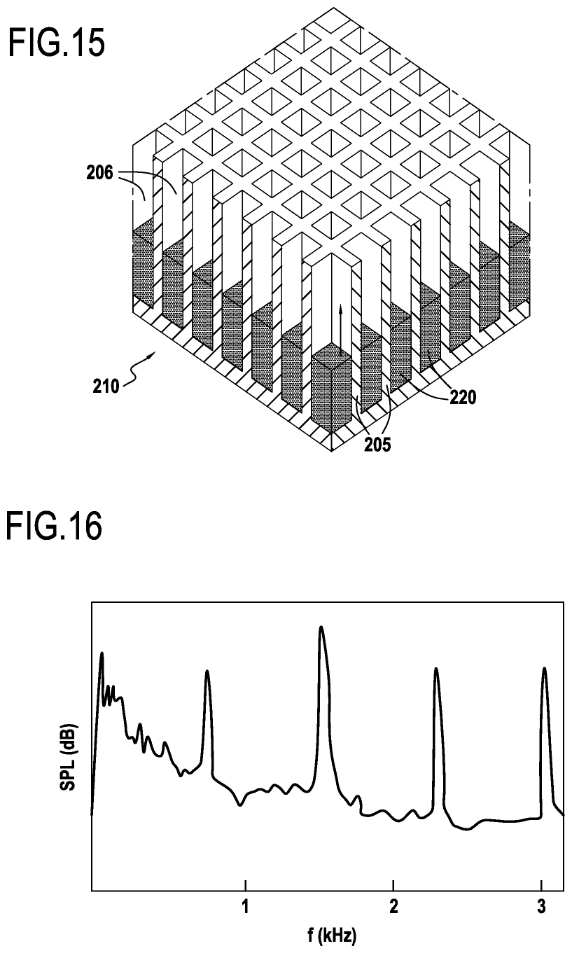

After having thus manufactured the mold 210, in a subsequent step, a fluid material 220 can be introduced into the mold 210, so as to fill the channels 206 and other cavities of the mold 210, as illustrated in FIG. 15. This fluid material 220 may be a thermosetting resin, in particular an epoxy resin mixed with a crosslinking agent, such as that forming the abradable material sold by 3M® under the name Scotch-Weld® EC-3524 B/A. However, it could also be, for example, a molten thermoplastic polymer, such as polyetherimide (PEI) or polyetheretherketone (PEEK). In order to reinforce the acoustic meta-material 100′, particularly when it is intended to be disposed opposite rotating parts, and in particular the rotating blades of a fan 2, the fluid material 220 can also comprise suspended solid particles, for example silica beads or nanoparticles or fibers, for example carbon fibers, which will remain embedded in the mass after solidification of the fluid material 220. The filling of the cavities of the mold 210 with the fluid material 220 can be carried out by simple gravity, or be at least assisted by a pressure gradient.

Once the fluid material 220 fills the cavities of the mold 210, it can harden within these cavities. This solidification can be thermally induced, or at least accelerated, in a firing step, in particular when the fluid material 220 is a thermosetting resin. After this solidification has formed the acoustic meta-material 100′ in the cavities of the mold 210, the mold 210 can be eliminated so as to release the acoustic meta-material 100′. For this purpose, the material of the mold 210 can be a water-soluble material and in particular a water-soluble thermoplastic polymer, such as, for example, a polyvinyl alcohol (PVA), butanediol and vinyl alcohol (BVOH) copolymer, or a polylactic acid (PLA), and the removal of the mold 210 can be carried out by leaching this water-soluble material, for example in an ultrasonic bath, optionally heated to a temperature, for example, of 60 to 80° C., for 3 to 5 hours. After the acoustic meta-material 100′ is thus released from its mold 210, it can be dried, for example in an oven at 70° C. for one hour.

Although the present invention has been described with reference to specific exemplary embodiments, it is obvious that various modifications and changes can be made to these examples without departing from the general scope of the invention as defined by the claims. Furthermore, individual features of the different embodiments discussed may be combined in additional embodiments. Therefore, the description and drawings should be considered in an illustrative rather than a restrictive sense.

1-13. (canceled)

14. A process for manufacturing an acoustic meta-material, comprising the following steps:
manufacturing a mold by depositing a plurality of stacked strata each comprising a plurality of periodically repeated cells, separated by walls, the cells of the plurality of stacked strata being aligned so as to form channels,
filling the channels with a fluid material,
solidifying the fluid material, and
removing the mold.

15. The manufacturing process according to claim 14, wherein the cells have a hydraulic radius of between 5 μm and 600 μm.

16. The manufacturing process according to claim 14, wherein the walls have a minimum width of between 2 μm and 600 μm.

17. The manufacturing process according to claim 14, wherein the channels have a length of between 1 and 150 mm.

18. The manufacturing process according to claim 14, wherein the cells are substantially polygonal.

19. The manufacturing process according to claim 14, wherein the cells are substantially round or oval.

20. The manufacturing process according to claim 14, wherein a shape and/or size of cells of different strata, among the stacked strata, are different.

21. The manufacturing process according to claim 14, wherein the mold also comprises one or more lateral conduits between the channels.

22. The manufacturing process according to claim 14, wherein the mold is made of a water-soluble material, and the step of removing the mold is carried out by leaching.

23. The manufacturing process according to claim 14, wherein the additive manufacturing of the mold is carried out by molten wire deposition.

24. The manufacturing process according to claim 14, wherein the fluid material comprises a resin, and the step of solidifying the fluid material comprises polymerizing the resin.

25. The manufacturing process according to claim 14, wherein the fluid material comprises suspended solid particles.

26. A meta-material manufactured by the manufacturing process according to claim 14, including a plurality of columns extending from a common base.

27. A turbomachine including, as a sound absorber, the acoustic meta-material according to claim 26.
